(19) United States
(12) Patent Application Publication
(10) Pub. No.: US 2017/0209991 A1
(43) Pub. Date: Jul. 27, 2017

(54) TOOL WITH AN AXIAL PASSAGE

(71) Applicant: Hong-Jen Lee, Taichung (TW)

(72) Inventor: Hong-Jen Lee, Taichung (TW)

(21) Appl. No.: 15/004,952

(22) Filed: Jan. 24, 2016

(51) Int. Cl. B25B 23/00; B25B 13/46; B25B 13/06

(52) U.S. Cl. CPC B25B 23/0035; B25B 23/0028; B25B 13/065; B25B 13/46

(57) ABSTRACT

A tool includes a non-circular first engaging portion formed at the first end of a body, the first engaging portion has a first groove defined in the outside thereof. The first groove is located substantially at a middle portion of the first engaging portion. A second engaging portion is located at the distal end of the first engaging portion and has a second groove defined in the outside of the second engaging portion. The second groove is located close to the distal end of the second engaging portion. A function end is formed at the second end of the body. A passage is defined axially through the body.

### BACKGROUND OF THE INVENTION

1. Fields of the Invention

The present invention relates to a tool, and more particularly, to a tool with an axial passage defined therethrough, first and second grooves are defined in the outside of the tool so as to be connected with at least two other parts of different sizes.

2. Descriptions of Related Art

The conventional tool with an axial passage is disclosed in U.S. Pat. No. 2,651,230 and comprises a wrench with an engaging portion which is a polygonal recess for being connected with a socket. The engaging portion has a notch for receiving a bead therein. The bead is biased by a spring pin 26. A socket has a groove defined in the outside thereof. When the socket is engaged with the engaging portion, the bead is biased by the spring pin 26 and engaged with the groove to position the socket relative to the engaging portion. The socket has only one groove in the outside thereof for being engaged with the bead. The socket has only one function.

Another tool comprises a ratchet unit located in the wrench and the ratchet unit includes a driving portion which has hole. A notch is defined in the inside of the hole and a positioning aperture is defined in the center of the hole so as to receive the switch therein. A plate is located beneath the switch and is located in the hole. The plate has an engaging portion, a slot and a push portion. A ring is connected to the head driving portion and has a reception hole for receiving a spring therein. The push portion of the plate is inserted into the reception hole and the spring biases the push portion. However, when a socket is connected to the hole of the hole of the driving portion, the engaging portion of the plate is engaged with a groove in the outside of the socket. The wrench can only cooperated with the socket with the specific groove. In other words, the tool disclosed in U.S. Pat. No. 2,651,230 cannot be cooperated with the tool with the ratchet unit mentioned above.

The present invention intends to provide a tool with an axial passage and the tool improves the shortcomings mentioned above.

### SUMMARY OF THE INVENTION

The present invention relates to a tool and comprises a first engaging portion formed at the first end of the tool. The first engaging portion has a first groove defined in the outside thereof, wherein the first engaging portion is a non-circular portion, and the first groove is a semi-circular groove and located substantially at the middle portion of the first engaging portion. A tubular second engaging portion is located at the distal end of the first engaging portion and a second groove is defined in the outside of the second engaging portion and located close to the distal end of the second engaging portion. The second groove is a semi-circular groove, and the diameter of the second groove is smaller than that of the first groove. A function end is formed at the second end of the tool. A passage is defined axially through the tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tool of the present invention;

FIG. 2 is a side view of the tool of the present invention;

FIG. 3 shows that the tool of the present invention and a wrench;

FIG. 4 shows that the tool of the present invention and another wrench;

FIG. 5 is a perspective view to show that the tool of the present invention is connected to the wrench in FIG. 4;

FIG. 6 is a perspective view to show the second embodiment of the tool of the present invention;

FIG. 7 is a perspective view to show the third embodiment of the tool of the present invention;

FIG. 8 is a side view of the tool of the present invention in FIG. 7;

FIG. 9 is a perspective view to show the fourth embodiment of the tool of the present invention;

FIG. 10 is a side view of the tool of the present invention in FIG. 9;

FIG. 11 is a perspective view to show the fifth embodiment of the tool of the present invention, and

FIG. 12 is a perspective view to show the sixth embodiment of the tool of the present invention.

### DETAILED DESCRIPTION OF THE PREFERRED EMBODIMENT

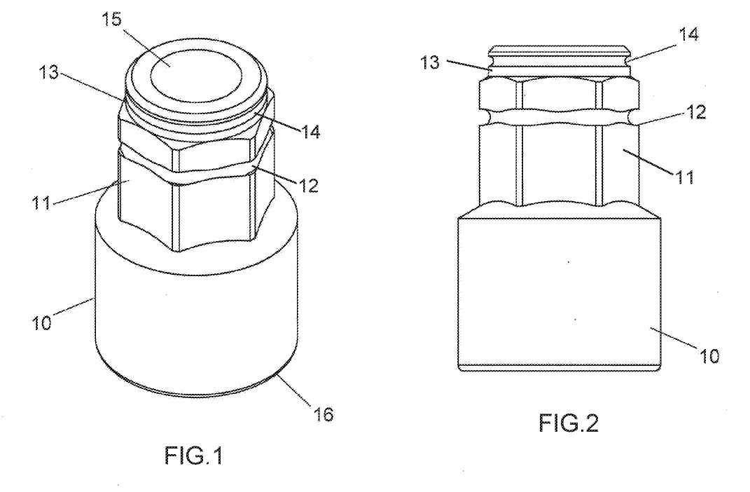

Referring to FIGS. 1 and 2, the tool of the present invention comprises an elongate body 10, a first engaging portion 11 formed at the first end of the body 10 and a first groove 12. A passage 15 is defined in the body 10. The first groove 12 is circularly along the central axe of the body 10 and the passage 15, and defined in the outside of the first engaging portion 11. The first engaging portion 11 is a non-circular portion. The first groove 12 is a semi-circular groove viewed in transversal cross section and located substantially at the middle portion of the first engaging portion 11. A second engaging portion 13 is located at the distal end of the first engaging portion 11 and is a tubular portion. A second groove 14 is circularly along the axe of the passage 15 defined in the outside of the second engaging portion 13 and located close to the distal end of the second engaging portion 13. The second groove 14 is a semi-circular groove viewed in transversal cross section. The diameter of the second groove 14 is smaller than that of the first groove 12. A function end 16 is formed at the second end of the body 10. The passage 15 is defined axially through the body 10 and communicates with the function end 16. In this embodiment, the body 10 is a socket, and the passage 15 is a circular passage or a rectangular passage. The function end 16 is a polygonal recess.

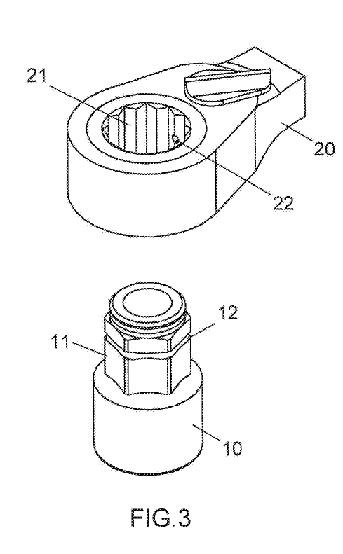

As shown in FIG. 3, a first hand tool 20 such as a ratchet wrench or a box-end wrench as shown, the first hand tool 20 has a polygonal third engaging portion 21 with which the first engaging portion 11 is engaged. The first engaging portion 11 is a hexagonal portion. The third engaging portion 21 has a bead 22 resiliently engaged with the first groove 12. When the first engaging portion 11 is engaged with the third engaging portion 21, the bead 22 can roll within the first groove 12.

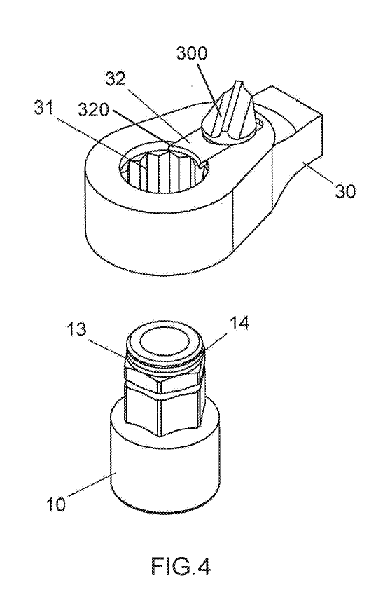

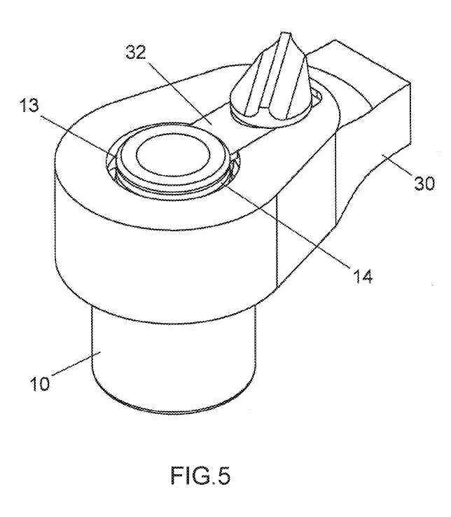

As shown in FIGS. 4 and 5, a second hand tool 30 such as a ratchet wrench or a box-end wrench as shown, the second hand tool 30 has a polygonal fourth engaging portion 31 with which the first engaging portion 11 is engaged. The fourth engaging portion 31 is a hexagonal recess. The second hand tool 30 has a switch 300, and the switch 300 has a connection member 32 which has a rounded distal end 320. When the first engaging portion 11 is engaged with the fourth engaging portion 31, the rounded distal end 320 of the connection member 32 is engaged with the second groove 14 to prevent the body 10 from dropping from the fourth engaging portion 31.

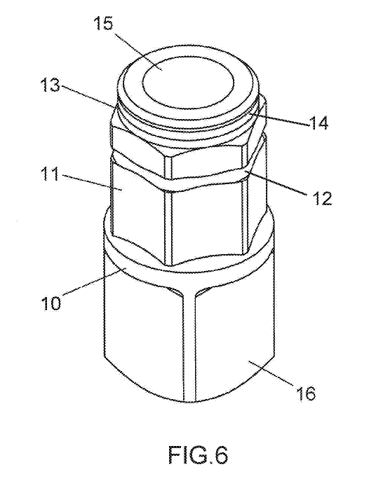

FIG. 6 shows that the body 10 is a connector and the function end 16 is a rectangular head which is engaged with a rectangular recess of other tools.

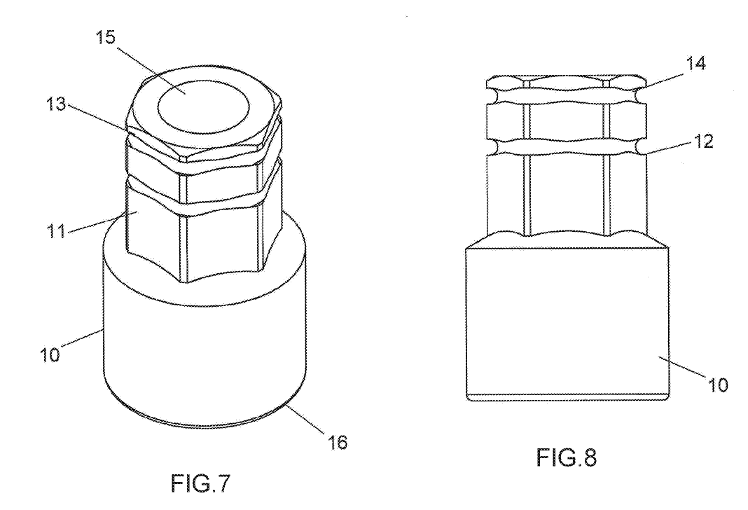

FIGS. 7 and 8 show that the cross section of the second engaging portion 13 is the same as that of the first engaging portion 11. The second engaging portion 13 and the first engaging portion 11 are a hexagonal portion respectively.

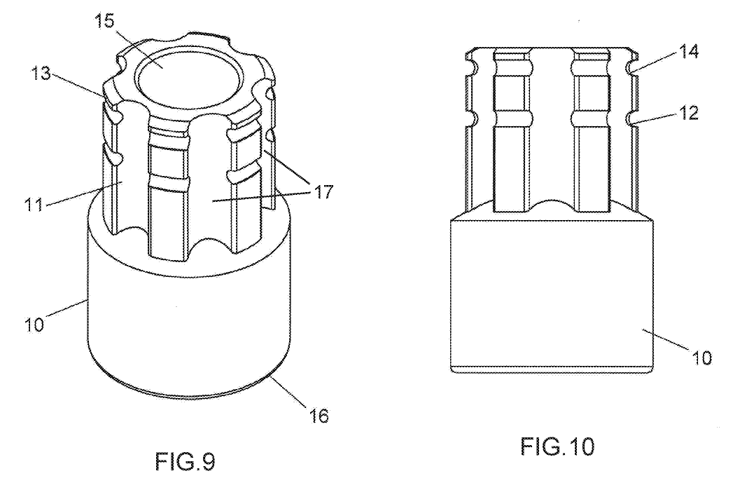

FIGS. 9 and 10, the cross section of the second engaging portion 13 is the same as that of the first engaging portion 11. Each of the first and second engaging portions 11, 13 is a tubular portion and has multiple grooves 17 in equidistance defined in the outside thereof and parallelly extending along the axe of the passage 15.

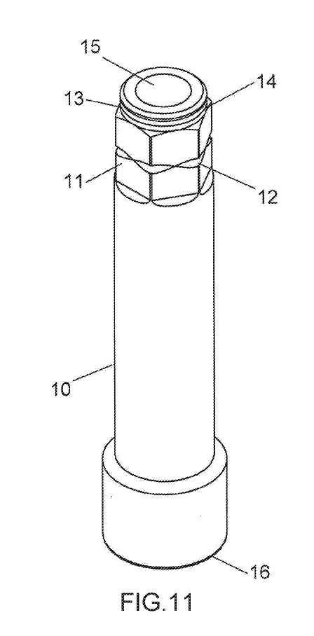

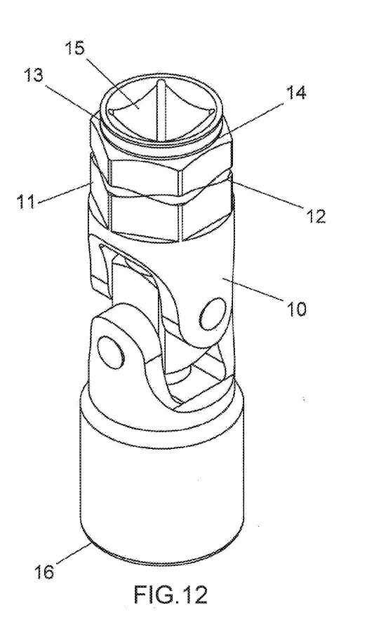

FIG. 11 shows that the body 10 is a connection rod. FIG. 12 shows that the body 10 is a pivotable connector. The passage 15 is a rectangular passage so as to be connected with a rectangular head.

Yet another embodiment of the present invention shows that the first groove 12 has a color and the second groove 14 has another color, such that the users can quickly distinguish the first and second grooves 12, 14.

The advantages of the present invention are that the body 10 has a first groove 12 and a second groove 14. A shown in FIGS. 3 to 5, the body 10 is engaged with the third engaging portion 21 of the first hand tool 20, the bead 22 is engaged with the first groove 12.

When the first engaging portion 11 is engaged with the fourth engaging portion 21 of the second hand tool 30, the connection member 32 of the second hand tool 30 is engaged with the second groove 14. The body 10 of the present invention can be cooperated with the first and second hand tools 20, 30.

As shown in FIGS. 6, 11 and 12, the body 10 of the present invention can be a socket, a connector, connection rod or a pivotable connector. The body 10 may be used in different ways.

As shown in FIG. 9, there are multiple grooves defined in the outside of the first and second engaging portions 11, 13. The multiple grooves are annular grooves. The hand tool to be cooperated with the body 10 of the present invention has multiple ridges protruding therefrom, so that the ridges are engaged with the grooves when the body 10 of the present invention is connected to the hand tools. Therefore, the body 10 of the present invention can be cooperated with at least three different ratchet wrenches.

While we have shown and described the embodiment in accordance with the present invention, it should be clear to those skilled in the art that further embodiments may be made without departing from the scope of the present invention.

What is claimed is:

1. A tool comprising:
an elongate body;
a first engaging portion being formed at a first end of the body and having a first groove defined in an outside thereof, the first engaging portion being a non-circular portion, the first groove being a semi-circular groove and located substantially at a middle portion of the first engaging portion, and the first groove being circularly along a central axe of the body;
a second engaging portion being located at a distal end of the first engaging portion and being a tubular portion;
a second groove being defined in an outside of the second engaging portion and located close to a distal end of the second engaging portion, the second groove being a semi-circular groove, the second groove being circularly along the central axe of the body, and a diameter of the second groove being smaller than that of the first groove;
a function end being formed at a second end of the body, and
a passage being defined axially through the body.

2. The tool as claimed in claim 1, wherein the body is a socket and the passage is a circular passage, and the function end is a polygonal recess and communicates with the passage.

3. The tool as claimed in claim 1, wherein the body is a socket and the passage is a rectangular passage, and the function end is a polygonal recess and communicates with the passage.

4. The tool as claimed in claim 1, wherein the first engaging portion is a hexagonal portion.

5. The tool as claimed in claim 1, wherein the body is a connector and the function end is a rectangular head.

6. The tool as claimed in claim 1, wherein a cross section of the second engaging portion is the same as that of the first engaging portion, the second engaging portion is a hexagonal portion.

7. The tool as claimed in claim 1, wherein a cross section of the second engaging portion is the same as that of the first engaging portion, each of the first and second engaging portions is a tubular portion and has multiple grooves defined in an outside thereof.

8. The tool as claimed in claim 7, wherein the multiple grooves are in equidistance and parallelly extending along the axe of the passage.

9. The tool as claimed in claim 1, wherein the body is a connection rod or a pivotable connector.

10. The tool as claimed in claim 1, wherein the first groove has a color and the second groove has another color.
